(19) United States
(12) Patent Application Publication
(10) Pub. No.: US 2026/0253466 A1
(43) Pub. Date: Aug. 27, 2026

(54) METHOD FOR OPERATING AN AUTHENTICATION SYSTEM, AND AUTHENTICATION SYSTEM WITH A PLURALITY OF UWB ANTENNAS

(71) Applicant: MARQUARDT GMBH, Rietheim-Weilheim (DE)

(72) Inventors: Bernd BAER, Rottweil (DE); Joerg FISCHER, Donaueschingen (DE); Antoine BACLE, Chauray (FR); Fabian FURTWAENGLER, Balingen (DE); Andreas KOCH, Rietheim-Weilheim (DE)

(21) Appl. No.: 18/877,124

(22) PCT Filed: Aug. 2, 2023
(86) PCT No.: PCT/EP2023/071401

§ 371 Date: Dec. 19, 2024

(30) Foreign Application Priority Data
Sep. 21, 2022 (DE) 10 2022 124 178.5

(51) Int. Cl. G07C 9/00

(52) U.S. Cl. CPC G07C 9/00309; G07C 2009/00555; G07C 2209/63; G07C 2209/64

(57) ABSTRACT

A method for operating an authentication system of a vehicle (3) for authenticating a portable authentication device in relation to the vehicle is provided for enabling vehicle functions for an operator. The authentication system comprises a portable ID transmitter and a vehicle-side authentication arrangement connected to a control device of the vehicle. and comprising a plurality of UWB modules (11), each with at least one UWB antenna (6). The method comprises: A) controlling UWB antennas to perform UWB communication(s) between the portable authentication device and the authentication arrangement or controlling multiple predetermined UWB antennas to perform UWB communication(s) between the portable authentication device and the authentication arrangement; B) performing the UWB communications; C) determining a respective distance in each UWB module; D) checking in each UWB module whether the respective distance is shorter than a predetermined maximum distance and respectively transmitting the result to the control device.

The invention relates to a method for operating an authentication system of a vehicle for authenticating a portable authentication device, in particular an ID transmitter, with a plurality of UWB modules, each with at least one UWB antenna, being provided on the vehicle. In particular, the invention relates to an authentication system with which an authentication of a portable authentication device, in particular of an ID transmitter, can be carried out in relation to the vehicle in order to enable vehicle functions for an operator who is carrying the portable authentication device, in particular the ID transmitter.

A wide variety of keyless entry systems are known from the prior art which can employ both low-frequency (LF) and high-frequency (HF) radio waves. Combination using LF/HF systems is also known from the prior art.

In radio-based authorization systems, security is of crucial importance, particularly against the compromising of the radio communication that is being carried out. Determining a position, a distance, or a similar value, for example in order to verify the plausibility of the bidirectional communication that is being carried out, as part of the enabling of a vehicle function using portable ID transmitters or portable authentication devices is known from the prior art.

For example, DE 10 2017 109 293 A1 or U.S. Pat. No. 11,277,742 B2, which comes from the same patent family, teaches a method and an associated system in which radio communication takes place successively between an ID transmitter or portable authentication device and various UWB antennas and the signal propagation delay is evaluated in a central control unit.

However, given that, according to this teaching, a plurality of UWB antennas are used one after the other and the signal propagation delays are determined serially in a central control device, such a method is comparatively protracted and error-prone.

It is therefore an object of the present invention to overcome the aforementioned drawbacks and to improve known authentication methods, in particular with regard to the communication between the authentication device and the vehicle, thus making secure yet speedy authentication possible.

The object is achieved according to the invention by a method with the features of claim 1 and by an authentication system with the features of the independent claim.

The method makes a provision that an authentication system of a vehicle is operated in order to authenticate a portable authentication device and, in particular, a portable ID transmitter in relation to the vehicle. The purpose of authentication is to enable a vehicle function for an operator who, in particular, is carrying the portable authentication device or the portable ID transmitter or approaches the same.

The authentication system comprises the portable authentication device, which is embodied in particular as a portable ID transmitter, and a vehicle-side authentication arrangement. The authentication arrangement comprises a plurality of UWB modules, each with at least one and preferably exactly one UWB antenna. The authentication arrangement or the UWB modules are connected to a vehicle-side control device, which is in particular an ECU and can be designed to control the authentication arrangement in order to carry out the method. Furthermore, the UWB module itself or a unit formed by the UWB module and the control device or the vehicle-side authentication arrangement can be a control unit (ECU) or be integrated into such a unit. The method itself provides for at least the following steps:
A) controlling all UWB antennas so as to carry out one UWB communication or multiple UWB communications between the portable authentication device and the authentication arrangement or controlling multiple predetermined UWB antennas so as to carry out one UWB communication or multiple UWB communications between the portable authentication device and the authentication arrangement;
B) carrying out UWB communications between the portable authentication device and the authentication arrangement;
C) determining a respective distance of the respective UWB antenna to the portable authentication device in each UWB module, particularly by detecting a propagation delay of a UWB signal of the UWB communication between the portable authentication device and the respective UWB antenna;
D) checking in each UWB module whether the respective distance is shorter than a specified maximum distance and transmitting the result of the check to the control device (ECU of the vehicle).

A portable authentication device is preferably understood to be able to be moved relative to the vehicle-side authentication arrangement. Accordingly, the portable authentication device can be a key or “smart key,” a mobile phone, a fob, or “smart fob” but also a stationary transmitter which, for example, is permanently installed on or in a garage, a charging station, or a gas pump.

Compared to the prior art, the present invention is distinguished in particular by the fact that a plurality of UWB modules, each with at least one UWB antenna, are used which, however, are not processed or used according to a preselection or according to a list that has yet to be determined. Instead, all available or existing UWB modules of the authentication arrangement are used or multiple UWB modules are used according to predetermined and unchangeable rules, for which purpose it is not necessary to take signal strengths or the like into account before the actual communication. Furthermore, at least the determination of the distance is not carried out centrally in a central control device, but decentrally in each of the UWB modules.

Since the UWB modules do not have to be selected according to a yet-to-be-determined list or according to signal strengths that have yet to be determined and, accordingly, multiple communication attempts do not have to be made first, authentication is faster. In addition, the distance determination is integrated into the respective UWB module, so that the distance determinations can be carried out in parallel and do not have to be carried out slowly one after the other or in parallel with enormous computational complexity in a central control device. This enables the processing in the vehicle control system to be simplified commensurately. The simultaneous use of a multiplicity of UWB modules also results in increased reliability and hence greater fault tolerance and resilience.

If the method or the above steps are repeated multiple times, different UWB modules can be used in each run as a function of the predetermined and fixed rules or lists. For example, with three UWB modules, a first run may use a first and second UWB module, a second run may use the first and third UWB modules, and a third run may use the second and third UWB modules. In a fourth run, all three UWB modules can still be used, for example. For example, one of the UWB modules could be used in each of the subsequent three runs. The allocation of which UWB module is used in which run is particularly fixed or determined by the fixed list or fixed rules.

Another aspect of the method according to the invention is based on the use of ultra-wideband communication.

The use of ultra-wideband radio signals (UWB radio signals) for some applications is known in principle from the prior art. However, transceivers that are ready for use have only recently become available on the market.

Ultra-wideband technology is a short-range radio communication based on the transmission of short signal pulses that cover a wide range of frequencies within a large frequency bandwidth. The breadth of the frequency ranges covered depends in particular on the regulatory requirements of the corresponding territorial area.

One drawback of UWB communication compared to established LF and/or HF communication is the comparatively high energy consumption of many currently available transceivers that are suitable for UWB communication.

However, UWB communication has the fundamental advantage that, due to the transmission of pulses, a distance determination is carried out using a propagation delay-based approach, which is often referred to as the time-of-flight method.

For example, the distance between a respective UWB antenna and the portable authentication device or the ID transmitter can be determined through transmission of a UWB signal from the respective UWB antenna to the portable authentication device, whereupon a UWB transceiver of the portable authentication device responds to this, and a unit that is coupled to the UWB antenna in the respective UWB module, for example a control means, evaluates the detected response signal. This is done by evaluating the time elapsed between transmission and reception. The distance to the authentication device, the processing time within the authentication device, and the distance from the authentication device to the respective UWB antenna are taken into account. If, as in this example, the propagation delay is evaluated on the vehicle side, only the processing time need be stored within the authentication device on the vehicle side—i.e., particularly in each UWB module—or be retrievable by each UWB module, enabling an appropriate correction to be made of the time measured on the vehicle side between transmission of the UWB signal and reception of the UWB response.

Experience has shown that the accuracy of such a UWB-based distance determination is substantially higher for the usual intended ranges than is the case with other methods, such as the signal strength determination of LF signals or triangulation of LF signals. The accuracy of UWB-based distance determinations is often in the order of 10 to 20 cm.

Because the pure propagation delay of the UWB signal is relatively short compared to the processing time, additional processing of the signal, for example for manipulation of the signal as part of a relay station attack, would be detected due to the unexpectedly high total time between the transmission of a UWB signal and the arrival of the corresponding response. Compromises, for example in the form of relay station attacks, are therefore only possible using very complex methods, if at all.

Another advantage of using UWB signals is that shadowing of the signals is very unlikely due to the large number of frequencies used. This is because, at least for some of the frequencies which are used simultaneously, there is a high probability that there will always be a line of sight between the transmitter and the receiver. One reason for this is that diffraction effects or reflections can be expected for some frequencies.

As described, a respective UWB antenna is part of a respective UWB module, which can in particular be a UWB transceiver. This allows for a compact design and easy configuration.

If the distance or the propagation delay of the UWB signal is shorter than a specified maximum distance or propagation delay, the vehicle can assume that the bidirectional UWB communication has not been extended. Depending on the security requirements, the maximum distance or propagation delay can be adjusted in such a way that, on the one hand, a sufficiently high accuracy of the distance determination is possible and, on the other hand, it can be assumed that a compromise of the UWB signal can be excluded or largely excluded within the recorded maximum distance or propagation delay.

In addition, LF and/or HF and/or BLE signals can be used to determine the distance, in which case a corresponding interface, which can also be provided integrally in the respective UWB module, is associated with some of the UWB modules and preferably every UWB module.

Another approach can be based on using data from one or more proximity sensors, for example. For example, a proximity sensor that is already provided in the vehicle or a proximity sensor that is arranged on the vehicle specifically for this purpose can output a proximity signal when the operator approaches, which is detected by a control means coupled to the proximity sensor and preferably provided in at least one of the UWB modules, whereupon the control means controls the associated UWB antenna of the respective UWB module.

A proximity sensor can also be coupled to multiple UWB modules. Multiple proximity sensors can each be associated with one UWB module or multiple UWB modules.

Advantageous and/or preferred refinements of the invention are additionally specified in the subclaims.

Another aspect of the invention relates to an authentication system of a vehicle for authenticating a portable authentication device or ID transmitter in relation to the vehicle in order to enable vehicle functions for an operator who is carrying the portable authentication device or ID transmitter. The authentication system is designed according to the independent claim and is provided in particular for the purpose of carrying out the method according to the invention.

The features disclosed above can be combined as required, provided this is technically possible and they do not contradict one another.

Other advantageous refinements of the invention are characterized in the subclaims and/or depicted in greater detail below together with the description of the preferred embodiment of the invention with reference to the figures. Brief description of the drawings:

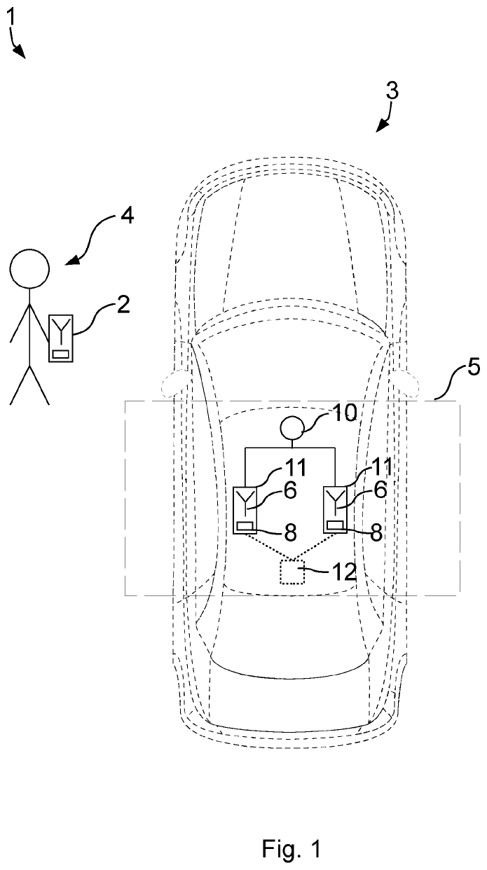

FIG. 1 shows a schematic representation of an authentication system;

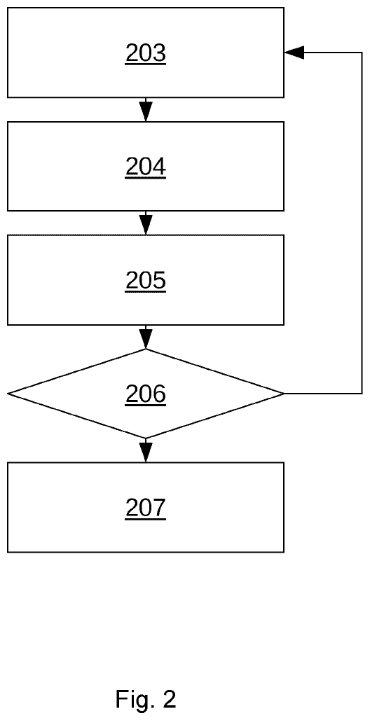

FIG. 2 shows a flowchart of an exemplary method sequence of the method according to the invention; and

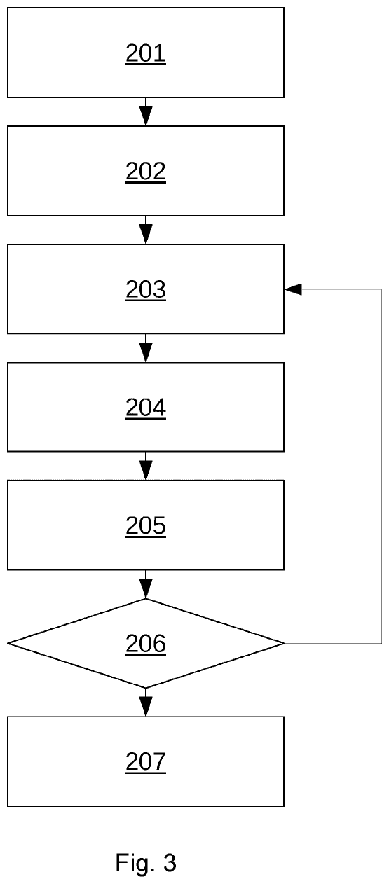

FIG. 3 shows a flowchart of an alternative method sequence of the method according to the invention.

The figures are schematic examples. Same reference symbols in the figures indicate same functional and/or structural features.

FIG. 1 shows an authentication system 1 with which the method according to the invention can be carried out. The authentication system 1 serves to authenticate a portable authentication device 2 embodied as an ID transmitter in relation to a vehicle 3. FIG. 1 shows a situation in which the ID transmitter 2 is in the possession of an operator 4. With the method according to the invention, the authentication of the portable ID transmitter 2 to the vehicle 3 can be carried out in order to enable the operator 4 who is carrying the portable ID transmitter 2 to access vehicle functions, such as starting the vehicle 3 or opening one or more of the vehicle doors.

In addition to the portable ID transmitter 2, the authentication system 1 comprises a vehicle-side authentication arrangement 5. The authentication arrangement 5 has a plurality of UWB modules 11—two UWB modules 11 in the present case—each with exactly one UWB antenna 6 for the sake of example. In the embodiment shown, the UWB antenna 6 is provided as an integral element of the respective UWB module 11 embodied as a UWB transceiver.

For the sake of example, the authentication arrangement 5 further comprises an LF interface 8 with at least one LF antenna as well as a proximity sensor 10 for each UWB module 11. Alternatively or in addition, an RF and/or BLE interface could also be provided. The LF interface 8 is integrated into the corresponding UWB module 11, but it could also be provided separately and only coupled to the respective UWB module 11 by means of signals. The proximity sensor 10 is arranged, for example, on the vehicle roof, on an underbody assembly, or within a door handle of, for example, the left front vehicle door or driver's door.

In the embodiment shown, the UWB modules 11 embodied as UWB transceivers and the LF interfaces 8 are integrally formed with each other and coupled to the proximity sensor 10 via a signal line. One UWB module 11 can be respectively coupled to one proximity sensor 10. As shown, alternatively a proximity sensor 10 can also be coupled to all or at least multiple UWB modules 11. If multiple proximity sensors 10 are provided, they can communicate with each other and with the UWB modules 11 via a bus, for example. Furthermore, the UWB modules 11 are coupled to a motor vehicle control unit 12 (ECU) which, in turn, can be implemented via a single signal line or a bus system. The motor vehicle-side control device 12 is suitable as a control means of the authentication arrangement for controlling and monitoring a method according to the invention and refinements thereof.

In the exemplary method sequence of the method according to the invention as it shown in FIG. 2, a determination of specific UWB modules 11 for communication can be omitted, since all of the UWB modules 11 or at least the UWB module 11 provided according to the fixed list or fixed rules are or is used directly. The method sequence can take place, for example, in response to an actuation of a proximity sensor 10 or as a result of a polling, although this is of secondary importance for the basic functioning of the method sequence shown.

According to FIG. 2, and as predetermined by a fixed list, in a first step 203 both the UWB antenna 6, for example the UWB module 11 on the left in FIG. 1, and the UWB antenna 6, for example the UWB module 11 on the right in FIG. 1, are immediately switched from a state in which they are not ready to transmit and/or receive to a state in which they are ready to transmit through actuation of the UWB antennas 6 from the respective UWB module 11 and in particular by means of the central control device 12.

The UWB antennas 6 send a respective UWB signal to the ID transmitter 2 simultaneously or with a minimal time offset. The respective UWB signal is then received by a UWB transceiver of the ID transmitter 2 and answered with a UWB response signal. The signals are received by the respective UWB antennas 6 in step 204. The distance or the signal propagation delay required by the respective UWB signal on the way to the ID transmitter 2 and additionally on the way back from the ID transmitter 2 is determined directly in the respective UWB module 11 and, in particular, without involving the vehicle-side control device 12, with a corresponding calculation time within the ID transmitter 2 being known to the respective UWB module 11 or being available for retrieval by the respective UWB module 11 from the control device 12 and thus being calculable from the time period actually measured.

In step 205, the respective distance or the respective propagation delay is calculated by the respective UWB module 11 and optionally forwarded to the central control device 12.

In step 206, a check is performed directly by the respective UWB module 11 as to whether the respective distance or propagation delay of the UWB signal is shorter than a predetermined maximum distance or propagation delay. The result is then forwarded to the control device 12. If the determined value is less than the maximum value, the ID transmitter 2 is considered by the authentication system 1 to be located within the space in which the vehicle function can be enabled (secure bubble). In addition, a compromise of the signal, for example through a relay station attack, is deemed not to have occurred. If, however, it is determined in step 206 that the distance or propagation delay for each UWB module 11 in particular is longer than the predetermined maximum distance or propagation delay, the method sequence of steps 203 to 206 is repeated starting with step 203, it being possible for other UWB modules 11 or even just individual UWB modules 11 to be controlled using the fixed list.

Steps 203 to 206 are repeated particularly according to the predetermined list or predetermined rules for the UWB antennas 6 or UWB modules 11 respectively provided. Termination occurs at the latest when this is provided for in the list or rules or when the ID transmitter 2 is to be regarded as being located within the specified space.

The method sequence shown in FIG. 3 differs from the method sequence shown in FIG. 2 in that an approach of the operator 4 is detected by the proximity sensor 10 in step 201. In step 202, the proximity sensor 10 outputs a proximity signal to at least one and preferably both UWB modules 11 or to the central control device 12, which then forwards this to at least one and preferably both UWB modules 11.

If the proximity sensor 10 is not already directly associated with one of the UWB modules 11, the control device 12 of the authentication arrangement 5 or the UWB modules 11 themselves recognize which of the proximity sensors 10 has detected the approach. In the method sequence shown, the proximity sensor 10 has detected an approach, which is why steps 203 to 207 are carried out analogously to the procedure according to FIG. 2.

The invention is not limited in its execution to the abovementioned preferred exemplary embodiments. Rather, a number of variants are conceivable which make use of the illustrated solution even in the form of fundamentally different embodiments.

1. A method for operating an authentication system of a vehicle for authenticating a portable authentication device, in particular a portable ID transmitter, in relation to the vehicle for the purpose of enabling vehicle functions for an operator who in particular is carrying the portable authentication device ID (2),
wherein the authentication system comprises the portable authentication device and a vehicle-side authentication arrangement which is connected to a control device of the vehicle or integrated into the control device,
wherein the authentication arrangement comprises a plurality of UWB modules, each with at least one UWB antenna, the method comprising at least the following steps:
A) controlling all UWB antennas so as to carry out one UWB communication or multiple UWB communications between the portable authentication device and the authentication arrangement or controlling multiple predetermined UWB antennas so as to carry out one UWB communication or multiple UWB communications between the portable authentication device and the authentication arrangement;
B) carrying out the UWB communications between the portable authentication device ID transmitter and the authentication arrangement;
C) determining a respective distance of the respective UWB antenna from the portable authentication device in each UWB module;
D) checking in each UWB module whether the respective distance is shorter than a predetermined maximum distance and transmitting the result of the check to the control device.

2. The method according to claim 1,
wherein the determination of the respective distance is carried out by detecting a propagation delay of a UWB signal of the UWB communication between the portable authentication device and the respective UWB antenna.

3. The method according to claim 1, wherein
it is determined according to a predetermined and fixed list and/or predetermined and fixed rules which of the UWB modules of the plurality of UWB modules are used for steps A) to D),
the list and/or the rules being stored in particular in the UWB modules or being retrievable from the same.

4. The method according to claim 3, wherein
steps A) to D) are carried out multiple times in succession during operation of the vehicle
and wherein the list and/or rules determine which of the UWB modules are used for a respective run.

5. The method according to claim 1, wherein
the authentication arrangement in each UWB module (11) has an LF interface (8) which is associated with the respective UWB antenna,
wherein a respective LF communication with an LF signal is carried out between the portable authentication device and each LF interface,
wherein the portable authentication device detects a respective signal strength of the LF signals and transmits the respective signal strength to the respective UWB module of the authentication arrangement,
wherein each UWB module determines a respective distance from the respective signal strength.

6. The method according to claim 1, wherein
the authentication arrangement in each UWB module has an RF interface which is associated with the respective UWB antenna,
wherein a respective RF communication with an RF signal is carried out between the portable authentication device and each RF interface,
wherein the portable authentication device detects a respective signal strength of the RF signals and transmits the respective signal strength to the respective UWB module of the authentication arrangement (5),
wherein each UWB module determines the respective distance from the signal strength.

7. The method according to claim 1,
wherein the authentication arrangement in each UWB module a BLE interface which is associated with the respective UWB antenna,
wherein a respective BLE communication is carried out with a BLE signal between the portable authentication device and each BLE interface,
wherein the portable authentication device detects a respective signal strength of the BLE signals and transmits the respective signal strength to the respective UWB module of the authentication arrangement,
wherein each UWB module determines the respective distance from the signal strength.

8. The method according to claim 1,
wherein the authentication arrangement has at least one proximity sensor which is associated with at least one of the UWB modules and, in particular, has one proximity sensor per UWB module which is associated with exactly one of the UWB modules,
wherein, when the respective proximity sensor detects an approach of the operator, this proximity sensor outputs a proximity signal identifying the proximity sensor, and the associated UWB module, when it detects the proximity signal, initiates the control of the UWB antenna to carry out a UWB communication between the portable authentication device and the authentication arrangement according to step A).

9. The method according to claim 1,
wherein the UWB communication is carried out at least intermittently in parallel with the execution of an LF communication and/or an HF communication and/or a BLE communication.

10. The method according to claim 1,
wherein UWB signal propagation delays between the respective UWB antenna of the UWB modules and the portable authentication device detected for the purpose of enabling vehicle functions are considered valid for a minimum time period and, during the minimum time period, no UWB communication is carried out by the respective UWB module or a UWB communication is only carried out in order to reset the minimum time period and thereby extend the validity.

11. An authentication system of a vehicle for authenticating a portable authentication device, in particular an ID transmitter, in relation to the vehicle for the purpose of enabling vehicle functions for an operator who is carrying the portable authentication device,
wherein the authentication system has the portable authentication device and a vehicle-side authentication arrangement,
wherein the portable authentication device has at least one authentication device UWB interface with an authentication device UWB antenna, and the authentication arrangement has a plurality of UWB modules, each with at least one UWB antenna,
and wherein the authentication device UWB interface and the UWB modules are set up for UWB communication with one another,
wherein the UWB modules of the authentication arrangement are set up to carry out a method according to any one of the preceding claims.
